(19) United States
(12) Patent Application Publication
(10) Pub. No.: US 2006/0080173 A1
(43) Pub. Date: Apr. 13, 2006

(54) Coupon dispensing system

(75) Inventors: Douglas L. Robinson, Ithaca, NY (US); Kenneth S. Westort, Ithaca, NY (US)

Correspondence Address: AQUILLA PATENTS & MARKS, PLLC, 221 COE HILL ROAD, CENTER HARBOR, NH, 03326-3605, US

(73) Assignee: Optical Products Development Corp., Elmira, NY (US)

(21) Appl. No.: 11/241,507

(22) Filed: Sep. 29, 2005

Related U.S. Application Data
(60) Provisional application No. 60/615,276, filed on Oct. 1, 2004.

(51) Int. Cl. G06Q 30/00

(52) U.S. Cl. 705/14

(57) ABSTRACT

A coupon dispensing system includes a touch-screen device presenting one or more product category icons that can be activated by a user's touch, a coupon printer for printing coupons based on one or more selections made by a user touching an image of a coupon on the touch-screen, independent of whether the user makes or has made any purchases, a computer, microprocessor device or other device for controlling the operations of selecting and printing coupons, and a method of attracting customers to said coupon dispensing system including a flat panel display for displaying advertising or a real image projection system for projecting into a space in front of said coupon dispensing apparatus a real image created from one or more sources that transmit, reflect or emit light.

### REFERENCE TO RELATED APPLICATIONS

This application claims an invention, which was disclosed in Provisional Application No. 60/615,276, filed Oct. 1, 2004, entitled “COUPON DISPENSING SYSTEM”. The benefit under 35 USC § 119(e) of the United States provisional application is hereby claimed, and the aforementioned provisional application is hereby incorporated herein by reference in its entirety.

### BACKGROUND OF THE INVENTION

1. Field of the Invention

The invention pertains to the field of coupon dispensing technology. More particularly, the invention pertains to methods and apparatus for dispensing coupons, and more particularly coupon dispensing in grocery stores.

2. Description of Related Art

The present invention pertains to all phases of coupon delivery and management, including apparatus operational design, remote delivery of coupons and remote control of said apparatus, procedures in marketing services, and related value propositions to stores, manufacturers and consumers.

The offering of manufacturers' discount coupons has been commonplace in the grocery industry for years. Manufacturers typically place coupons in magazines, newspaper supplements, and mailings. However, there are significant disadvantages to conventional coupon dispensing methods, primarily because redemption rates are low, averaging about 2%.

In recent years, Catalina Marketing has offered coupons at the checkout counters at grocery stores and pharmacies. The coupon dispensers are tied directly to the store's database and offer coupons that directly relate to the customer's personal buying history, or relate directly to the purchases that the customer made at that visit. The coupons are printed and offered to the customer after their purchases are made, and are to be used during a subsequent visit to the store. However, there are significant disadvantages to this method of coupon dispensing. One major disadvantage is that the customer may lose or forget about the coupon by the next visit, and it does not promote store loyalty, since it can be redeemed in other stores. Another disadvantage is that the method does not directly link the coupon with what the customer will actually buy during the next visit, only what the customer history shows they may buy.

Another coupon dispensing system is described in U.S. Pat. No. 6,151,587, which is directed to coupon dispensing equipment. The invention incorporates two separate printers, with one printing a separate slip with the coupon, indicating the aisle where the product is displayed. The apparatus includes a computer, two printers and a touch-screen, and offers coupon selection and printing at the point of sale.

The present invention also pertains to a real image projection system and, in particular, to such a system in which a real image of a three-dimensional object or a two-dimensional source, such as, for example, a photograph or computer screen, is formed in space, giving the illusion that a real object exists at that point in space, when in reality it does not.

Real image projection systems typically incorporate spherical or parabolic mirrors for imaging. One of the earliest working real image displays is depicted in White's 1934 publication of “Fundamentals of Optics”. It shows a spherical mirror positioned behind a table. A flower vase is mounted below the table and a real image of the vase is projected sitting on the table-top. Visual display systems are well known in the art and typically use a curved reflector with a beamsplitter positioned at a 45 degree angle to the curved reflector's optical axis to divert the input beam path at a 90 degree angle to the viewing axis or imaging beam path. For example, this method has been used since the early 1950s for flight simulation, and commonly is referred to as the WAC window system. These systems typically are used in an on-axis configuration, meaning that the optical axis, or the untilted curved reflector's center of radius, is located along the viewing axis. When viewing such an on-axis system, any object within the viewing area images within the system. Various real image projections systems are described in a number of publications, such as, for example, U.S. Pat. Nos. 6,598,976, 6,650,470, 6,612,701, and 6,733,140, the complete disclosures of each of which are hereby incorporated herein by reference in their entireties.

### SUMMARY OF THE INVENTION

A coupon dispensing system includes a touch-screen device presenting one or more product category icons that can be activated by a user's touch, a coupon printer for printing coupons based on one or more selections made by a user touching an image of a coupon on the touch-screen, independent of whether the user makes or has made any purchases, a computer, microprocessor device or other device for controlling the operations of selecting and printing coupons, an optional magnetic card reader and/or barcode scanner, and a method of attracting customers to said coupon dispensing system including a flat panel display for displaying advertising or a real image projection system for projecting into a space in front of said coupon dispensing apparatus a real image created from one or more sources that transmit, reflect or emit light.

In the preferred embodiment, the coupon dispensing system comprises a kiosk that includes a 3D real image projection system and provides 3D advertising. In an alternative embodiment, advertising is provided by a flat panel display, such as a LCD monitor. In another alternative embodiment, the coupon dispensing system includes a scent generator, and in yet another embodiment, the system includes means for gender recognition of viewer's or user's of the coupon dispensing apparatus. In yet another alternative embodiment, the coupon dispensing system is part of a network that can include multiple coupon dispensing units, some of which may be smaller “satellite” units.

### BRIEF DESCRIPTION OF THE DRAWINGS

FIG. 1 depicts the primary embodiment of the apparatus, comprising a 3D display, touch-screen interface, coupon printer and kiosk enclosure.

FIG. 2 depicts a typical computer system for the coupon dispensing apparatus, and the components required.

FIG. 3 depicts a side view of an embodiment of the apparatus showing the 3D display system incorporated into the device.

FIG. 4 depicts a smaller coupon dispensing apparatus kiosk with 3D projection with similar capabilities as that shown in FIG. 1 and FIG. 3.

FIG. 5 depicts a system as described in Embodiment 2 with similar components as that in Embodiment 1 except it does not contain a 3D display. The system uses a Flat panel LCD or CRT to display advertising and is designed primarily as a satellite coupon dispensing station networked to the coupon dispensing apparatus of Embodiment 1.

FIG. 6 depicts a satellite coupon dispensing apparatus that does not incorporate a 3D display or an LCD advertising screen, and is primarily used as an additional interface to supplement Embodiment 1 or embodiment 2.

FIG. 7 depicts a system as described in Example 2, with similar components as shown in Example 1, except that it does not include a 3D display or a flat panel LCD Attracter. The system preferably includes an infinity tunnel display with a virtual 3D image at the center display advertising.

FIG. 8 depicts the scent generator device that triggers a specific scent based on the computer's command signal.

FIG. 9 depicts a coupon dispensing apparatus, which includes networked satellite coupon dispensing stations.

FIG. 10 depicts the “Main Screen” of the LCD interface.

FIG. 11 depicts the “Instruction Screen”, which is activated by touching the welcome screen in FIG. 7.

FIG. 12 depicts the “Coupon Selection Screen”, which is activated by pressing a category icon as described in FIG. 8.

### DETAILED DESCRIPTION OF THE INVENTION

The following definitions are to be used throughout the specification and claims, unless otherwise specifically stated:

Asphere—a curve of conical baseline, such as spherical, parabolic, hyperbolic, or elliptical, and which includes an aspheric surface of revolution. Aspheric curves provide combinations of higher order terms in the curve formulas to create surfaces of revolution that, in combination, produce imagery with reduced aberrations. The deviation from a real conic section, in effect, allows extra degrees of design-freedom, which can be used by the optical designer to improve imagery in real or virtual imaging systems. Each of these standard conic curves has significant shortcomings, when used in a particular configuration, such as that of the invention described herein. An aspherical curve deviation allows the system optics to be optimized to perform much better off-axis or when the object location deviates from the focal point. Every optical system has inherent errors and aberrations as a function of natural physics, and slight curve deviations possible in an asphere will compensate for these phenomena. In all of the claims herein, the term “aspheric” shall refer to a curve of conical baseline, such as spherical, parabolic, hyperbolic, or elliptical, and which includes an aspheric surface of revolution in at least one of the reflectors of the system.

Field-Of-View—the angle at which a full real image can be viewed.

Lens Element—refers to a lens, lens system, or any optical arrangement that will modify the focal point of an image. The term is used generally to describe a supplemental optical element to the primary optical system, which, in the present invention, comprises primarily two aspheric reflector segments, as described herein.

On-Axis—the orientation of optics to each other, wherein the focal points of each parent optic and the vertex or optical center of each parent optic are all on a common axis or imaginary straight line.

Optical Aberration—a natural optical phenomenon found in all optics. The inability of lenses and mirrors to form a perfect image is due to naturally occurring phenomena called optical aberrations. It is the optical designer's task to minimize the inherent optical aberrations found within an optical system, to an acceptable level. This may be accomplished by the use of various lenses, mirrors, optical surface shapes and materials to balance and cancel defects in the image. An asphere design is a method of minimizing aberrations by optimizing optical surface shape. Common aberrations are astigmatism, chromatic aberration, coma, field curvature, distortion and spherical aberration. Aberrations affecting image quality increase as the imaging location is moved away from the focal point and optical axis of an optic. This phenomena can be minimized by maintaining the image and target object substantially at the focal point of a parabola or asphere.

Reflector—a reflective optic, referring to a substrate having a mirror coating or partially reflective coating, such as, but not limited to, a semi-transparent beamsplitter coated optic. This coating may be either a rear or front surface coating, depending generally on the surface of the substrate that is used to reflect.

Parent Optic—the full parabola, conic, or asphere from which a segment is cut or otherwise derived.

Segment—the term segment refers to a smaller optic cut from its parent optic and located between the optical center and the edge of the parent optic.

Object—the actual object or the light source from which a real image is formed. An object (or target object) is defined as any image source that reflects, emits, or transmits light, and includes, but is not limited to, such things as real objects, video or computer monitors, or projection devices, screens and the like.

Vertex—a point on the reflective surface of the parent optic that is coincident with the optical center of the parent parabola or asphere. The vertex of a segment is defined as the point on the reflective surface coincident with the optical center of the parent optic from which the segment is cut or otherwise derived.

The present invention encompasses all phases of coupon delivery and management, including kiosk operational design, remote delivery of coupons and remote control of said kiosk, procedures in marketing services, and related value propositions to stores, manufacturers and consumers. The detailed description that follows are particular for various specific configurations, however, the scope of the present invention is not limited to these examples or any other particular configuration.

The present coupon dispensing system differs substantially from prior art apparatus and methods. The coupon dispensing apparatus of the present invention is intended to be located near the entrance to a grocery store and to allow consumers to select and print one or more coupons that relate to one or more purchases the consumer plans to make during the present store visit, and most likely will use the coupons in that particular store on that visit, which builds store loyalty. The coupon dispensing system of the present invention does not require tracking the purchasing history of particular customers and therefore is potentially less intrusive to customer privacy than prior art systems.

In a preferred embodiment, the coupon dispensing system comprises a kiosk that includes a 3D real image projection system and provides 3D advertising. As a viewer approaches the floating real image produced by the real image projection system, an input touch-screen display allows the viewer to select and print coupons and optionally displays advertising and/or prompts the viewer to enter the viewer's e-mail address to receive various free promotional items.

The real image projection system preferably includes an aspheric mirror configuration (as described in U.S. Pat. No. 6,612,701, the complete disclosure of which is hereby incorporated herein by reference in its entirety), or a tilted optical system designed for high brightness and low ghost reflections (as described in U.S. Pat. Nos. 6,798,579, 6,733,140, and U.S. Pub. No. 2003-0210380 A1, the complete disclosures of which are hereby incorporated herein by reference in their entireties). Using aspheric optics significantly improves image quality, particularly when the system is used in an off-axis arrangement. The system optionally also includes a circular polarizing window or beamsplitter configuration (as described in U.S. Pat. No. 6,163,408, the complete disclosure of which is hereby incorporated herein by reference in its entirety).

### COUPON DISPENSING APPARATUS EXAMPLES

In the preferred embodiment, the coupon dispensing apparatus kiosk is the customer interface. It includes a computer, a touch-screen interface, and at least one kiosk printer for printing coupons, and a method of attracting customers to the device. This attractor optionally is a 3D display, an LCD panel, or other devices or advertising intended to attract consumers to the kiosk. The customer typically then makes a selection from, for example, 10 to 12 category buttons on the screen, such as Meat & Deli, Frozen Foods, Dairy, etc. When the category is selected, the touch-screen presents ten coupons on the screen with descriptions, a graphic representation of the product and the coupon offer or discount. The customer can then touch the screen coupon and a paper coupon is immediately printed. More coupons for that category are available by touching the next page icon, where another ten coupons are displayed for selection. Customers can easily navigate between categories and through the coupon screens to quickly print all the offered coupons they desire. The optimum number of coupons per category is ten with a total of three hundred coupons.

The kiosk software is designed to be dynamic, preferably being controlled and configured from a remote location. The system uses data files to define component positions on the screen, general screen layouts, coupon data, and display sequences. By updating the data files, the entire contents and visual appearance of the interface can be changed. The kiosk computer has an FTP server to allow data transfer to and from the kiosk, controlled from a central remote location. To update the coupon selections, one simply sends a new data file and corresponding graphics if required, to the kiosk via a modem or other similar device. The software also has reporting routines incorporated that log the individual transactions, such as the number of each coupon printed per day, and the total number of coupons printed each hour of each day. The reporting data files are sent to a central location each day for compiling and evaluation. This provides advertisers with a report as to activity and performance of their coupon and the program in general.

The central control software contains an FTP server, which is a file transfer protocol, to remotely communicate with the kiosks. The software includes several modules, including a database for storing data, a coupon design application that creates the data files for coupon layout, a database query application to compile reports relating to coupon dispensing, scheduling applications and financial billing applications, as well as general management application modules.

Coupon sales typically are targeted directly to the product manufacturers, however advertising brokers also are target customers, as they are responsible for placing coupon advertising for grocery stores in local newspapers and publications. Billings are made monthly, based on the number of kiosks which offer the coupon. Each manufacturer is provided with a report of total coupons printed per day, as well as total coupons printed per hour each day. Billings are not based on redemption rates in this particular model, however, since coupons have unique identifiers, they can be easily cross-referenced with the store database to determine redemption rates.

The value proposition of the business method makes it attractive to stores, manufacturers, and consumers. Consumers are able to acquire their coupons at the store, instead of through magazines and newspapers, and consumers can select only the coupons they want, and can use those coupons during the same visit as they are printed. Manufacturers are targeting consumers with coupons, and redemption rates will be extremely high, since consumers are not likely to print a coupon unless they intend to use it. Stores also will benefit by creating customer loyalty, since the coupons printed are redeemable in their store prior to the purchase.

### Example 1

### Coupon Dispensing Apparatus with 3D Advertising

In a preferred embodiment, the kiosk includes a 3D real image projection system and provides 3D advertising. The video files are stored on the hard drive and the kiosk software reads the filenames from a play list data file and displays the video clips in sequence in a loop. Typically a loop is made up of approximately 15 to 20 advertisements of 10 to 15 seconds each in duration. The play list data file and the Mpeg video files are transferred from a central remote location to the kiosk by means of a modem and FTP file transfer software. The files are stored in predefined hard drive directories. The backend software, located at a remote location, develops the play list and prepares the video files for transfer by FTP server. The kiosk software also records the play time of each video with a timestamp in a video report file which is accessible from the remote location by FTP server. The data file provides the administrator with playtimes of all advertisements, which is subsequently used in developing reports to the advertiser and for billing purposes. The 3D advertising embodiment serves as an attractor to the coupon dispensing apparatus. Besides offering advertising, the 3D floating images captures the attention of consumers and makes them aware of the coupon dispensing service that the coupon dispensing apparatus provides.

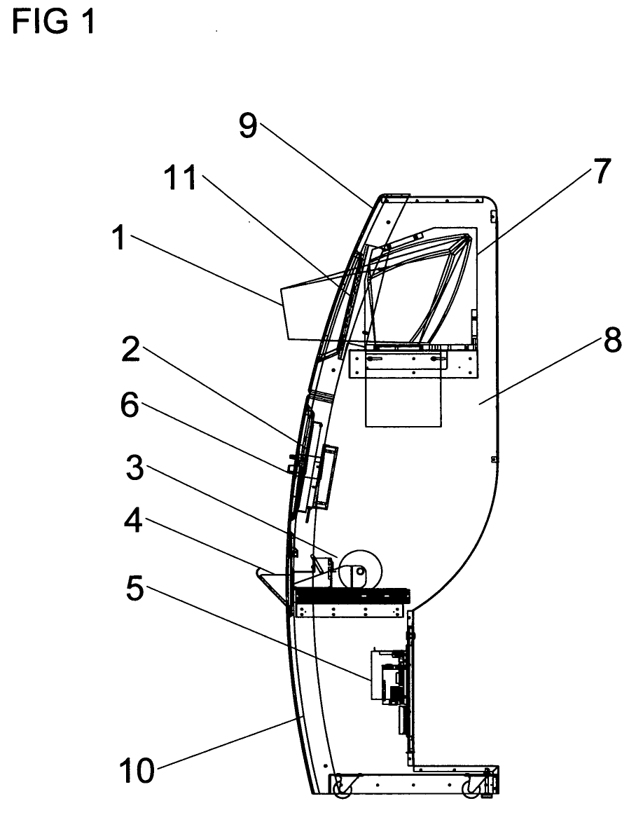

Referring now to FIG. 1, a preferred embodiment of the coupon dispensing apparatus is shown. The apparatus includes an enclosure (8) which contains a computer system (5) in the lower portion of the enclosure, a kiosk coupon printer (3) that prints manufacturers' coupons (4), a LCD touch-screen (2) interface, whereby navigation and coupons are selected by the user, a magnetic swipe card reader (6) for swiping loyalty cards, and a 3D real image projection system (7) that projects a moving video image (1) out in front of the kiosk as an attractor.

In the kiosk depicted in FIG. 1, the window area (11) preferably comprises a neutral density filter glass with an anti-reflective coating on the surfaces thereof. The main housing of the kiosk (8) preferably is constructed of metal while the front panels (9,10) preferably are constructed of vacuum formed ABS plastic for durability and appearance. The drawing and description depict a typical construction and appearance, however the materials and appearance are not limited to those specified in the drawing description and are for example only.

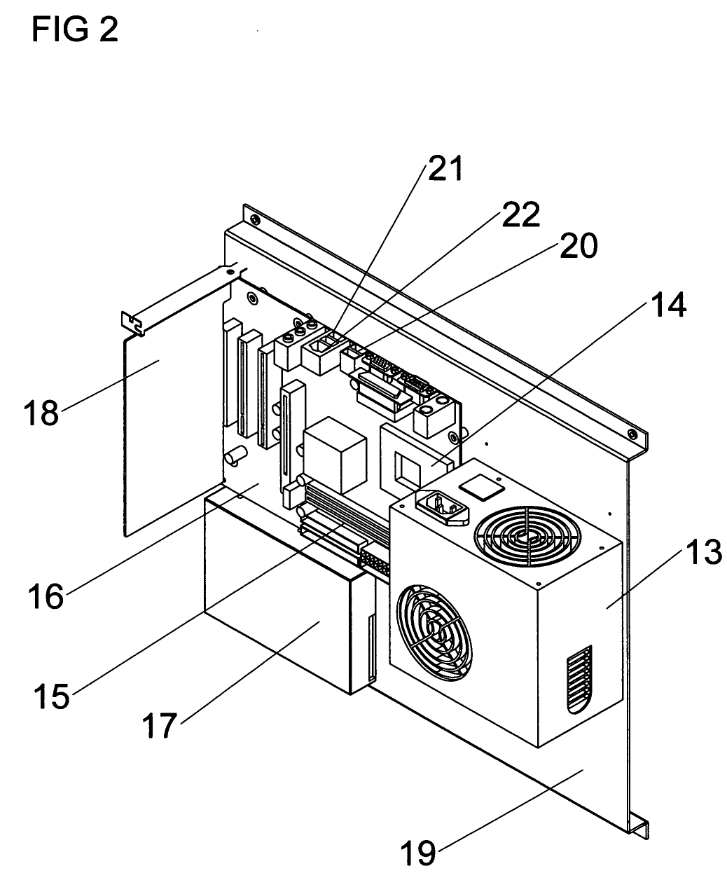

FIG. 2 depicts a typical computer contained within the coupon dispensing apparatus. The example shown includes a power supply (13), CPU (14), Memory (RAM) (15), a mother board (16), a hard drive (17) for data and program storage, a Mpeg video decoder board (18), and a mounting chassis to contain the components (19). The motherboard (16) preferably should include at least two USB ports (21), a network adapter port (20), as well as a modem port (22). The computer assembly must be of substantial speed and contain sufficient memory and storage to simultaneously decode and play videos, operate the coupon software, and facilitate the remote transfer of data. The example depicted uses a 2.8 GHz Athelon processor (14), and preferably at least a 40 MB hard drive (17), 512 MB of RAM (15), and a 500 Watt power supply (13), however actual specifications may vary based on the particular application, preference and availability, and are not limited to those described herein.

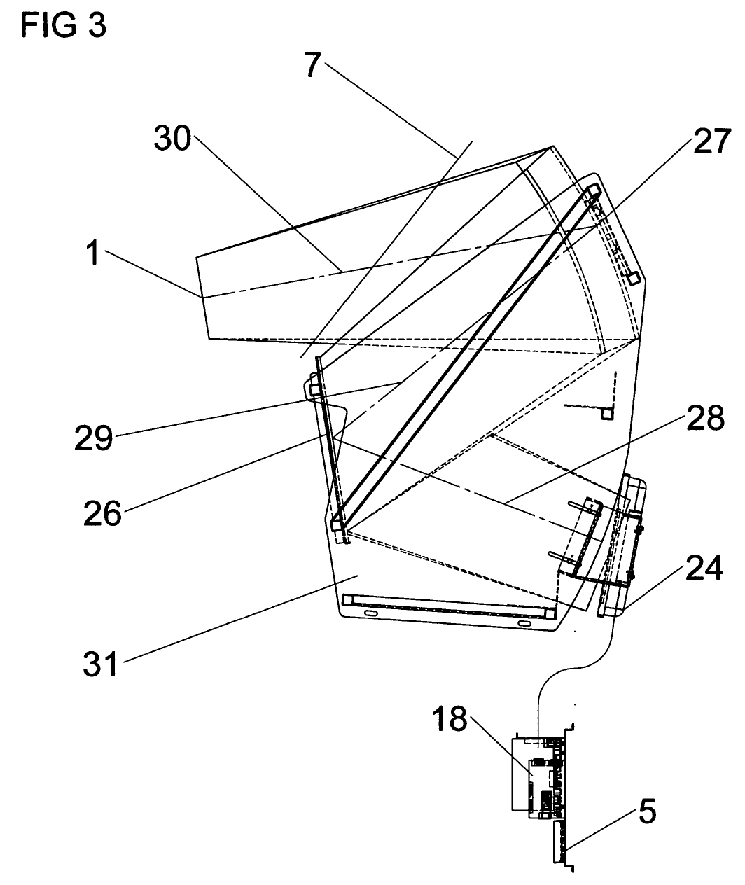

FIG. 3 depicts a side view of an embodiment of the apparatus, showing the 3D display system which is incorporated into the device. The kiosk enclosure has an internal structure or chassis (31) which houses and aligns the optical components of the 3D display. A suitable real image display system, as depicted in the drawing, is disclosed in U.S. Pat. No. 6,612,701 (the complete disclosure of which is incorporated herein by reference), however it is not limited to that particular design. The chassis assembly (31) contains a LCD monitor (24) of sufficient brightness, contrast, and fields of view. Optimum LCD specifications are 500 units of brightness, 500 to 1 contrast level, and 160 degree field of view in both vertical and horizontal axis. The light (28) emits from the LCD (24) and reflects off the face of a front surface mirror (26), which is positioned so that the reflected light beam (29) from the center of the LCD (24) strikes the center of the curved mirror (27). The curved mirror (27) is positioned at an angle of approximately 14 degrees angled down from horizontal. The diverging light beam (29) from the front surface mirror (26) strikes the surface of the curved spherical mirror (27), and becomes a converging beam of light (30) which comes to focus at the focal point of the system forming a floating real image (1) in front of the system. The system preferably incorporates a filter (7). The imaging light or beam path (30) passes through a neutral density window (7). The window has an absorption of approximately 30% evenly across the visible light spectrum. This reduces the ghost imagery within the system and enhances image contrast. The LCD (24) source of the 3D image (1) is connected to the Mpeg decoder card (18) installed in the computer (5) and controlled by the software and play list.

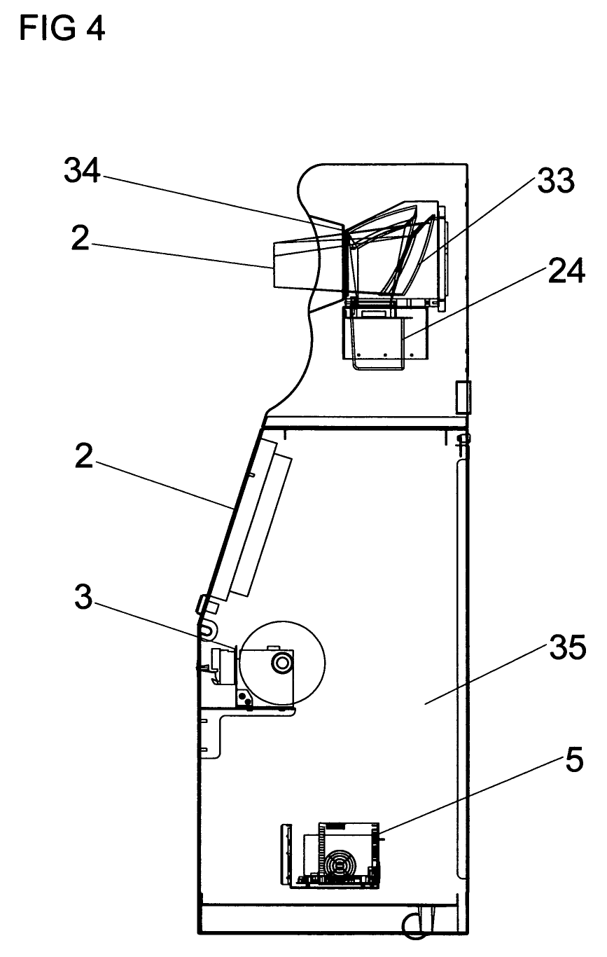

FIG. 4 depicts a smaller coupon dispensing apparatus kiosk with 3D projection with similar capabilities as the system shown in FIG. 1 and FIG. 3. The kiosk (35) shown is only to represent one possible aesthetic design and is not limited to that design or size. In this example, the 3D projection device (33) is a dual optic real image projection system, as, for example, described in U.S. Pat. No. 6,598,976 (the complete disclosure of which is incorporated herein by reference), which collects light emitted from a source monitor (24), and forms a real image (1) at the focal point out in front of the kiosk in viewer space. The device has similar components to the apparatus described in FIG. 1, such as a computer (5), a coupon printer (3), and a touch-screen LCD interface (2). The drawing depicts a smaller, more compact system.

### Example 2

### Coupon Dispensing Apparatus with 2D Advertising

In a second embodiment, the coupon dispensing apparatus kiosk incorporates an LCD panel to display advertising videos, instead of a 3D projection device. The same software and delivery methods are incorporated as used with the embodiment described in Example 1.

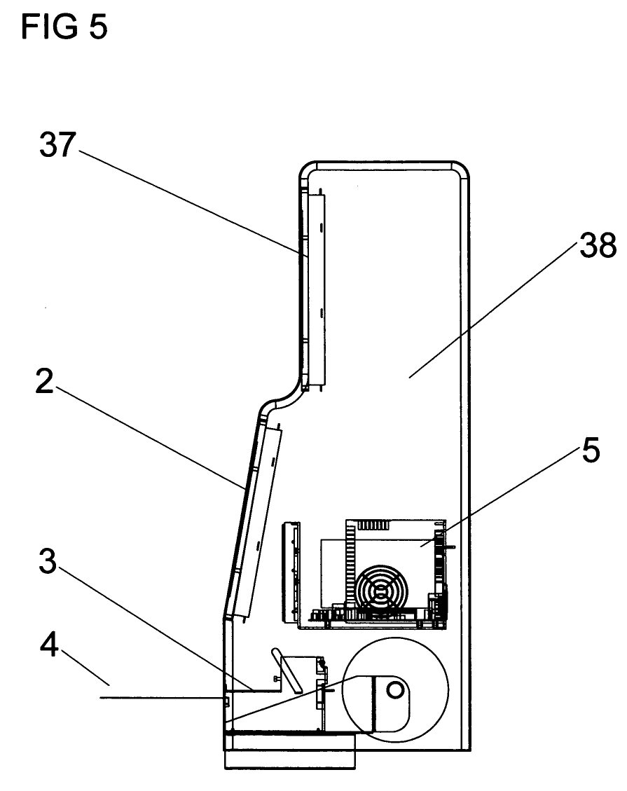

FIG. 5 depicts a system as described in Example 2, with similar components as shown in Example 1, except that it does not include a 3D display. The system preferably includes a flat panel LCD to display advertising and is intended primarily as a satellite coupon dispensing station, which is networked to the coupon dispensing apparatus of Example 1, although the system of Example 2 is not limited to use as a secondary satellite coupon dispensing apparatus. The satellite kiosk depicted is a table model (38) that incorporates a touch-screen LCD interface (2) for selection of coupons, a coupon printer (3) for printing coupons (4), a computer (5), and an LCD display (37) for displaying advertising and to act as an attractor. The embodiment depicted optionally is a full floor model kiosk or a satellite table model kiosk or coupon dispensing station within an array of coupon dispensing systems.

### Example 3

### Coupon Dispensing Apparatus with No Advertising

In a third embodiment, the coupon dispensing apparatus incorporates no advertising display and is used only to supplement the system of Embodiment 1 and Embodiment 2.

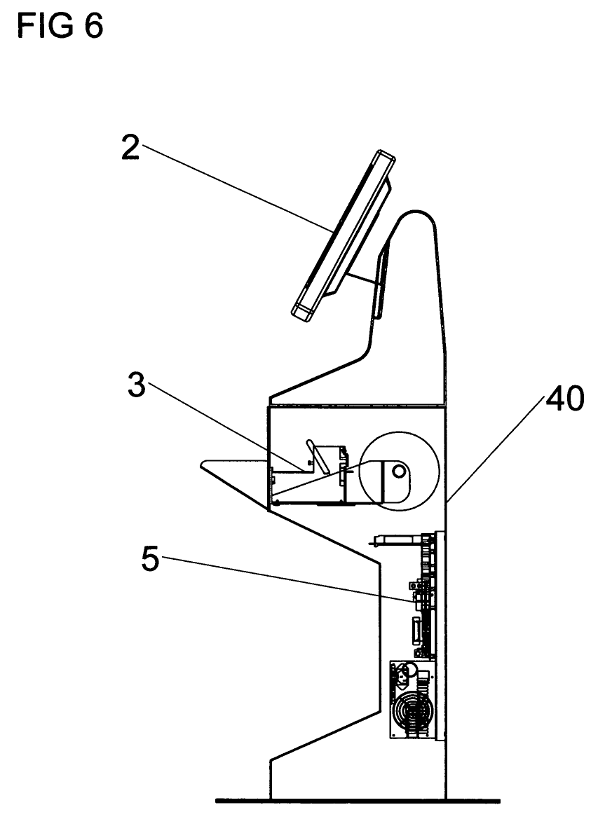

FIG. 6 depicts a satellite coupon dispensing apparatus that does not incorporate a 3D display or an LCD advertising screen, and is primarily used as an additional interface to supplement to the system of Example 1 or Example 2. The satellite coupon dispensing apparatus incorporates a touch-screen LCD interface (2), a coupon printer (3), a computer (5), and a housing (40). The computer (5) is networked to the main system as depicted in FIGS. 1, 3, 4 or 5. As data files are delivered remotely to the main system, they optionally are also transferred to the satellite units by wireless or cable network.

In a large grocery store environment, a combination of some or all of the embodiments described herein optionally is used to form a store-wide coupon dispensing center. For example, near the store entrance, the 3D coupon dispensing apparatus is positioned to capture the attention of shoppers. Smaller coupon dispensing devices, or satellites, are located next to the 3D coupon dispensing apparatus to provide more stations for coupon dispensing, and/or attritional satellite units optionally are dispersed in various locations throughout the store. The satellite units optionally include LCD advertising screens, as described in Example 3, or smaller interfaces, as described in Example 5.

### Example 4

### Coupon Dispensing Apparatus with 2D Advertising

In a forth embodiment, the coupon dispensing apparatus incorporates an Infinity Tunnel Display System with a simulated 3D video image.

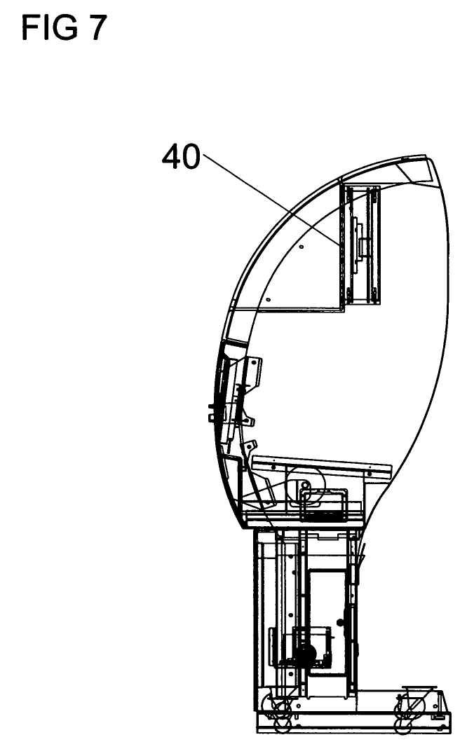

FIG. 7 depicts a system as described in Example 2, with similar components as shown in Example 1, except that it does not include a 3D display or a flat panel LCD Attracter. The system preferably includes an infinity tunnel display with a virtual 3D image at the center display advertising. The system incorporates a touch-screen LCD interface (2) for selection of coupons, a coupon printer (3) for printing coupons (4), and a computer (5), and an infinity display (38) for displaying advertising and to act as an attractor. The embodiment depicted optionally is a full floor model kiosk or a satellite table model kiosk or coupon dispensing station within an array of coupon dispensing systems.

### Example 5

### Coupon Dispensing Apparatus with Scent Generation

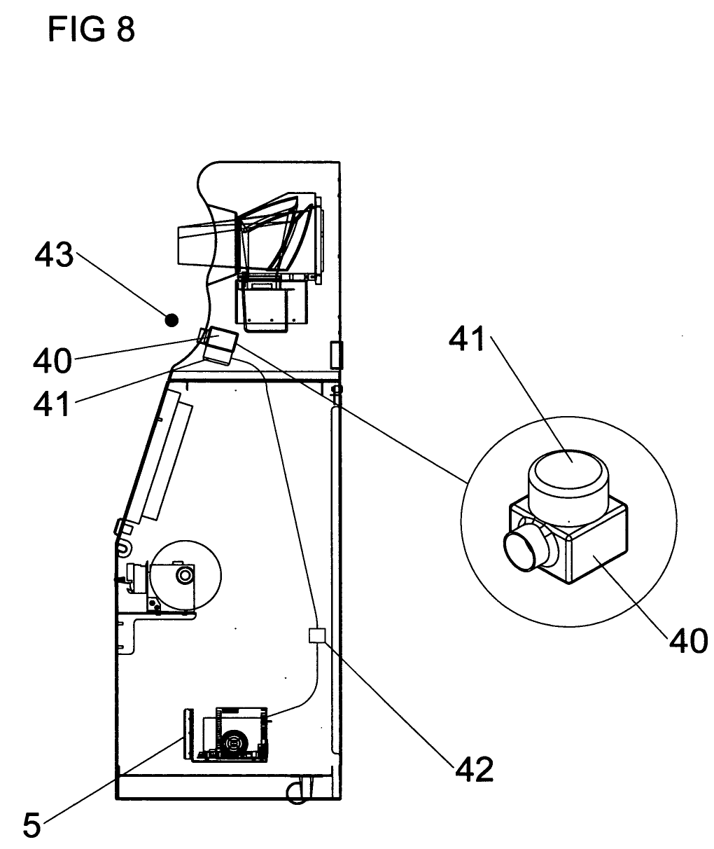

In a fifth embodiment, the coupon dispensing apparatus incorporates a scent generator device. FIG. 8 depicts the scent generator device that triggers a specific scent based on the computer's command signal. The scent device (40) consist of individual fans attached to the scent cartridge (41) and is activated by the computer by means of a SCR, silicon controlled rectifier (42), or by solid state relays, delivering the scent through the manifold and out the front of the kiosk into the customer's space (43). The computer (5) software reads the filenames of the 3D video that is currently playing, and activates the appropriate corresponding scent. For example, when an advertisement for laundry detergent is playing it activates a scent of the detergent. In the case of multiple scents, a manifold is used to selectively access up to 12 different scents. The scent can also be activated by the selection of product categories. As an example, when the category for baked goods is activated, the scent of fresh baked bread is activated.

### Example 6

### Coupon Dispensing Apparatus with Gender Recognition

In a sixth embodiment, the coupon dispensing apparatus incorporates a gender recognition module. The gender recognition software is activated by an individual selecting a coupon for printing. It records the gender, age range, and ethnic category of the individual operating the coupon dispensing apparatus, and makes an entry of that information in the data file along with the coupon data that the coupon dispensing apparatus records. This provides marketing and demographic information on who is using the service and the demographics associated with individual coupons and products. It also allows for targeting consumers with specific advertising, based on analysis of the demographic data and recognition of the consumer's profile.

### Example 7

### Coupon Dispensing Apparatus with Satellite Stations

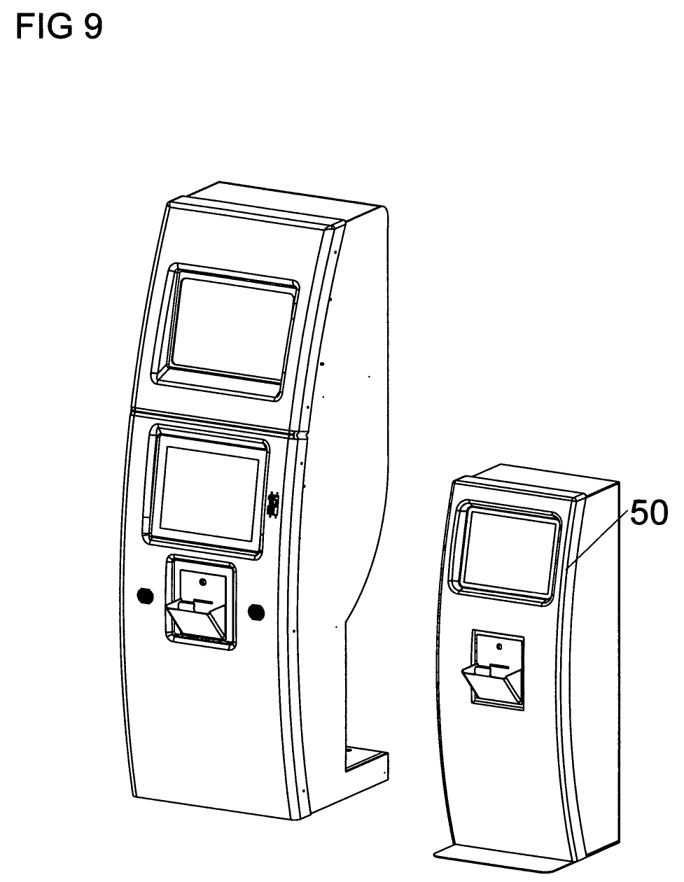

In a seventh embodiment, as depicted in FIG. 9, the coupon dispensing apparatus includes networked satellite coupon dispensing stations (50). The apparatus contains a touch-screen LCD interface, a coupon printer, a computer, and a network card or interface to access the primary coupon dispensing apparatus device as described in Example 2 or Example 3.

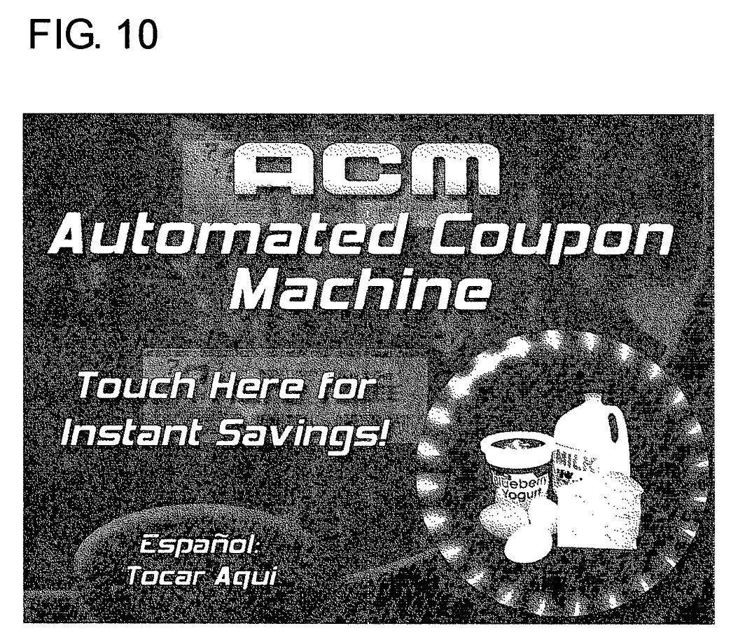

FIG. 10 depicts the “Main Screen” of the LCD interface. It is animated so as to attract consumers to the coupon dispensing apparatus, and upon touching any part of the screen will activate the unit an begin the selection process for coupons.

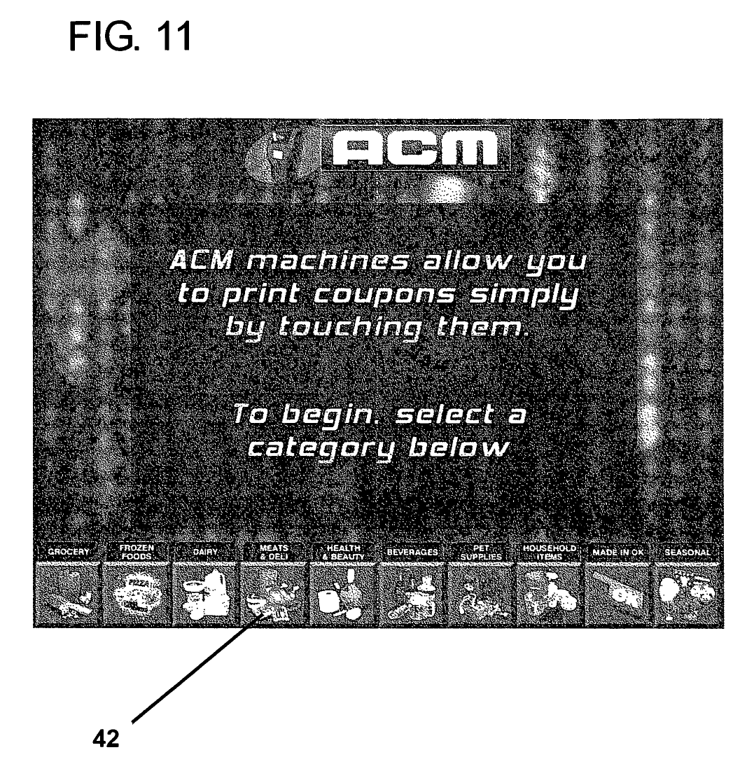

FIG. 11 depicts the “Instruction Screen”, which is activated by touching the welcome screen in FIG. 7. It instructs the user to select a category by pressing a category icon (42) along the bottom of the screen.

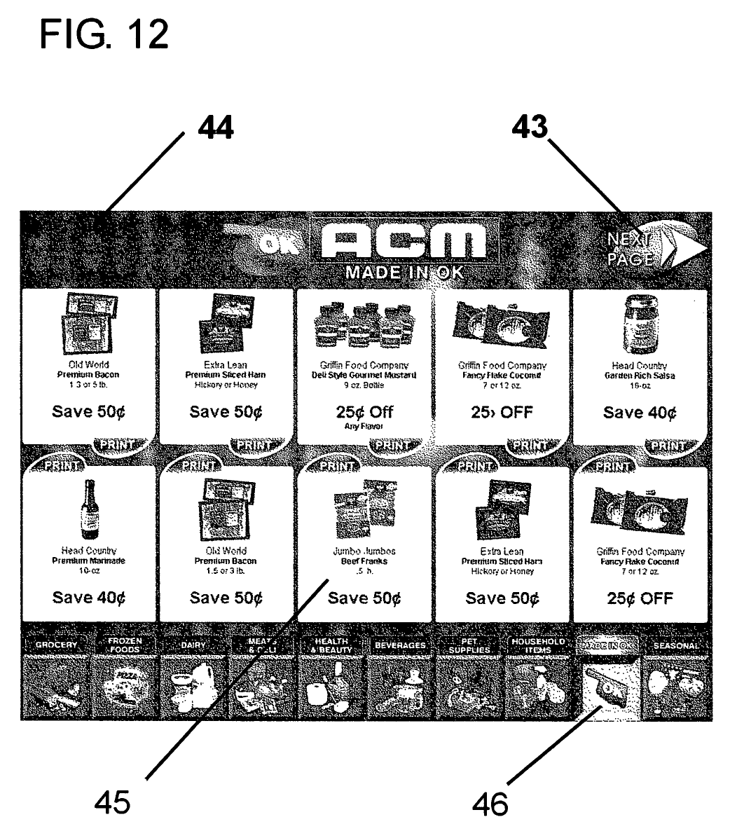

FIG. 12 depicts the “Coupon Selection Screen”, which is activated by pressing a category icon as described in FIG. 8. The screen shows ten coupons (45) per screen. Pressing the “Next Page” icon (43) at the top right of the screen displays ten new coupons (45). Continuing to press the “Next Page” icon (43) will display additional coupon pages for the selected category (46). Once all available coupon pages are displayed, the “Next Page” icon (43) is disabled. The “Previous Page” icon (44) returns the coupon screen to the previous displayed ten coupons (45) until the first ten coupons are displayed, then is disabled. Pressing a screen “Coupon” (45) activates the coupon printer and a paper coupon is printed.

In a preferred embodiment, the coupon dispensing system prints either bitmap coupons or coupons generated from data fields, whereby a designated field of the data file contains a filename of the bitmap coupon, if it is available, or otherwise it generates the coupon based on the remaining data fields of the record. For example, a coupon data file and data field structure and format of the coupon record might include (but is not limited to) the following record fields and formats:

| | |
|---|---|
| CouponID | (unique Identifier) |
| Bitmap Name | (Null) |
| Graphic Image | (AcmeSoapImage.jpg) |
| Barcode | (0135747840135) |
| Name | (“Acme Soap”) |
| Description1 | (“Laundry Detergent”) |
| Description2 | (“16 ounce box”) |
| Offer | (“40 cents off any 16 oz. box”) |
| Expiration | (“April 2, 2005”) |
| Disclaimer | (text provided by the manufacturer) |

A field structure for bitmap coupons might include, but is not limited to:

| | |
|---|---|
| CouponID | (unique identifier) |
| Bitmap Name | (AcmeSoap.jpg) |
| Graphic Image | (Null) |
| Barcode | (Null) |
| Name | (Null) |
| Description1 | (Null) |
| Description2 | (Null) |
| Offer | (Null) |
| Expiration | (Null) |
| Disclaimer | (Null) |

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A coupon dispensing system comprising:
a) a touch-screen device presenting a plurality of product category icons that can be activated by a user's touch;
b) a coupon printer for printing coupons, based on one or more selections made by said user touching one or more coupon images on said touch-screen, independent of whether said user makes or has made any purchases;
c) a computer, microprocessor device or other means for controlling the operations of selecting and printing said coupons; and
d) a real image projection system, or LCD panel, video monitor, infinity light tunnel, or other conspicuous means for attracting consumers to said coupon dispensing system.

2. The coupon dispensing system of claim 1, wherein said real image projection system projects into a space in front of said coupon dispensing apparatus a real image created from one or more sources that transmit, reflect or emit light.

3. The coupon dispensing system of claim 1, further comprising a plurality of selections within each product category, each presenting a single or plurality of coupons based on one or more selections made by a viewer touching an image on the touch-screen.

4. The coupon dispensing system of claim 1, further comprising a modem or network card for connecting said system to the Internet or to transfer data through an FTP server in communication with said computer, microprocessor device or other means for controlling the operations of selecting and printing said coupons.

5. The coupon dispensing system of claim 1, further comprising an Mpeg-2 video decoder card installed in the computer to decode and output video advertising to a monitor.

6. The coupon dispensing system of claim 5, further comprising an LCD or CRT display or an infinity light tunnel with a simulated 3D video screen, for displaying said advertising.

7. The coupon dispensing system of claim 2, wherein said real image projection system comprises an optical system, which inputs diverging light from said source, refocuses said diverging light into a converging beam, and then forms a real image of said source in a space in front of said real image projection apparatus.

8. The coupon dispensing system of claim 7, wherein said source comprises at least one target monitor and said real image projection system further comprises means for providing at least one electronic video signal to said at least one target monitor.

9. The coupon dispensing system of claim 8, wherein said video signal is provided by a DVD player, laser disk player, computer, and/or other video means, interfaced with a computer and/or computer driven controller.

10. The coupon dispensing system of claim 9, wherein said computer and/or computer driven controller has one or more VGA outputs and/or video outputs.

11. The coupon dispensing system of claim 10, wherein said one or more video outputs are NTSC, PAL, S-Video, composite, RGB, and/or other format compatible with said real image projection system.

12. The coupon dispensing system of claim 10, wherein said one or more video outputs are Mpeg-1, Mpeg-2, or AVI format, or other video format capable of output of a video signal from stored data.

13. The coupon dispensing system of claim 9, wherein said computer and/or computer driven controller is built into a video output device, or a video device including an RS-232 port or serial port or other connector for providing communication with an external controller or computer.

14. The coupon dispensing system of claim 1, further comprising one or more scent generators operatively connected to a manifold for directing specified scents into space in front of said coupon dispensing system.

15. The coupon dispensing system of claim 1, further comprising means for interpreting the gender and/or age group of viewers of said coupon dispensing system who are facing toward said touch-screen device.

16. The coupon dispensing system of claim 2, further comprising a monitor for displaying advertising.

17. The coupon dispensing system of claim 2, further comprising one or more scent generators operatively connected to a manifold for directing specified scents into space in front of said coupon dispensing system.

18. The coupon dispensing system of claim 2, further comprising means for interpreting the gender and/or age group of viewers of said coupon dispensing system who are facing toward said touch-screen device.

19. A satellite coupon dispensing system comprising:
a) a touch-screen device presenting a plurality of product category icons that can be activated by a user's touch;
b) a coupon printer for printing coupons, based on one or more selections made by said user touching one or more coupon images on said touch-screen, independent of whether said user makes or has made any purchases;
c) a computer, microprocessor device or other means for controlling the operations of selecting and printing said coupons;
d) a network card or other means for operatively connecting said system to a network.

20. The satellite coupon dispensing system of claim 19, operatively connected to the Internet through a modem or via a store internal network.

21. The satellite coupon dispensing system of claim 19, wherein said satellite coupon dispensing system is networked to the system of claim 1.

22. The satellite coupon dispensing system of claim 19, wherein said satellite coupon dispensing system is networked to the system of claim 2.

23. The coupon dispensing system of claim 2, further comprising one or more scent generators operatively connected to a manifold for directing specified scents into space in front of said coupon dispensing system.

24. The system of claim 15, wherein said means for interpreting the gender of viewers includes means for evaluating said viewer photographically, and determining gender, age grouping, and ethnic origin of said viewer, and recording corresponding data

25. The system of claim 18, wherein said means for interpreting the gender of viewers includes means for evaluating said viewer photographically, and determining gender, age grouping, and ethnic origin of said viewer, and recording corresponding data.

26. The system of claim 1, wherein said coupon includes one or more items of information selected from the group consisting of:
i) a bitmap graphic of the product;
ii) one or more barcodes compatible with manufacturer's product codes;
iii) a product name and description;
iv) a special offer or discount offered with the coupon;
v) a disclaimer stating the limitations and rules for redemption;
vi) an expiration date of the offer; and
vii) a designation of coupon type.

27. The system of claim 1, wherein said system creates a data file and records, based on coupon selection and printing, and transfers said data to a remote location through an FTP server.

28. A method for promoting goods or services, comprising the steps of:
a) deploying the coupon dispensing system of claim 1 at a grocery store;
b) prompting viewers attracted to said system to select and print one or more coupons; and
c) promoting said goods or services via said coupons.
